(19) United States
(12) Patent Application Publication
(10) Pub. No.: US 2025/0184431 A1
(43) Pub. Date: Jun. 5, 2025

(54) SECURE CALL PROCESSING VIA PROXY

(71) Applicant: SYCURIO LIMITED, Guildford Surrey (GB)

(72) Inventors: Thomas J. BALDWIN, Fleet (GB); Gary E. BARNETT, Brentwood, TN (US)

(21) Appl. No.: 18/840,754

(22) PCT Filed: Feb. 23, 2023
(86) PCT No.: PCT/EP2023/054576

§ 371 Date: Aug. 22, 2024

(30) Foreign Application Priority Data
Feb. 23, 2022 (GB) 2202499.6

(51) Int. Cl. H04M 3/54; H04M 3/436

(52) U.S. Cl. CPC H04M 3/54; H04M 3/436

(57) ABSTRACT

Processing a communication or call between a first entity and a second entity comprising routing an initial call between the first entity and the second entity via an intermediate entity, monitoring for a trigger signal, and upon detecting the trigger signal, re-routing the call additionally via a further entity adapted to process the call for sensitive information encoded in the call received from the first entity.

### FIELD

This invention relates to secure processing of sensitive information during a communication or call, such as a telephone or video call. Aspects relate to a call processing system for routing a call between a first entity and a second entity via an intermediate entity which is adapted to reconfigure or re-route the call when required via a further entity adapted to process sensitive information encoded in the call data signals.

### BACKGROUND

When a payment transaction is undertaken during a telephone call, the process can be agent-assisted, i.e., a caller can be assisted by an agent acting on behalf of a merchant or service provider. The agent is typically located at a contact or call centre and acts as an intermediary between the caller, the merchant or service provider and the payment provider.

It is preferable for security reasons that the agent does not have access any sensitive information, such as payment details, health information or certain other personal identifying information (PII), such as social security or passport information, which may be required to be provided by the caller.

An example of a call processing system is described in the applicant's international PCT patent application WO2009136163, wherein sensitive information is transmitted by the caller during a telephone call as DTMF tones, and a call processor is located between the caller and the agent which, for example when operating in a ‘secure mode’, blocks or ‘masks’ these tones, preventing them from reaching the agent, and processes the encoded sensitive information in order to interact with an external entity. At other times, when sensitive information is not being transmitted by the caller, the call processor may allow DTMF tones to pass unblocked (i.e., in the clear), which may allow for the caller to navigate a tone-driven options menu, such as may be provided by the contact centre. Voice signals may at various times be allowed to pass through unhindered to allow caller and agent to remain in contact.

Implementing agent-assisted call processing systems may lead to high costs and scalability issues due to hardware and licensing requirements, especially when seeking to integrate them with existing systems. There is therefore a need for more efficient call processing systems, preferably ones which offer similar or additional security advantages. The present invention aims to address these and other issues.

### SUMMARY

The foregoing and other objectives are achieved by the features of the independent claims.

Further implementation forms are apparent from the dependent claims, the description and the Figures.

According to a first aspect there is provided a method of processing a communication or call between a first entity and a second entity, the method comprising: routing an initial call between the first entity and the second entity via an intermediate entity; monitoring for a trigger signal; and upon detecting the trigger signal, re-routing the call additionally via a further entity adapted to process the call for sensitive information encoded in the call received from the first entity.

Re-routing the call may comprise: initiating a second call from the intermediate entity to the further entity; and joining the initial call and second call thereby re-routing the call between the first entity and the second entity via the intermediate entity and the further entity.

Also provided is a call processing system for processing a communication or call between a first entity and a second entity, the system comprising: an intermediate entity, adapted to route an initial call from the first entity to the second entity via the intermediate entity; a further entity, adapted to process the call for sensitive information encoded in the call received from the first entity; and a controller, adapted to monitor for a trigger signal and upon detecting the trigger signal to effect re-routing of the call additionally via the further entity.

The first entity may be a caller; the second entity may be an agent, such as at a contact centre.

The intermediate entity may comprise a session border controller (SBC), potentially adapted to have the functionality described. Furthermore, the intermediate entity may be further adapted to perform one or more functions of the controller.

The further entity—or third party—may be a call processor (as described in WO2009136163 and WO2018172771 for example) adapted to process the call data for sensitive information received from the first entity. In some embodiments the call processor comprises one or more constituent components such as a Call Control Module (CCM), for handling the call itself, a Data Processing Module (DPM), for handling and processing the sensitive information and optionally a security device (SEO). The call processor or one or more of its constituent components—and therefore aspects of its functionality—may be located within the call centre or external to it and/or geographically separated.

As described herein, ‘on-demand’ processing involves the direct insertion of a third party (the further entity or call processor) in the call between the first and second entities. The terms party or entity may be used interchangeably.

It will be appreciated that some aspects are applicable both to communication via audio (telephone) and also via video, whether implemented via circuit-switching or packet-switching networks.

Generally, the call comprises a plurality of data streams: typically at least one data stream for voice, optionally video, data and at least one data stream for associated call signalling data.

This method described herein may require minimal active participation of the parties, thus reducing the potential points of failure. For example, some prior art systems which seek to address similar problems may involve setting up a conference call between parties and the selective muting of call legs in real time.

Furthermore, this method is entirely invisible to the network or PSTN; no special network features or behaviours are required.

Likewise, when deployed in a contact centre, this method may be completely invisible to the contact centre. This may allow for contact centre usage statistics to be collected without requiring additional analysis or call reconstruction, as may be required in prior art systems to account for single agent-customer interactions being split into multiple, isolated call fragments. In some prior art systems comparison of call handling times may be difficult even if the call statistics have been reconstructed. One reason for this may be that several “call on hold” or “call being transferred” steps may be involved, each taking a finite amount of time, which may not be included in the summed total call duration. For example, if there are four such steps, each step taking 0.5 s, then the call duration may appear to be 2 seconds shorter than it really is—which may be a significant amount of time for a contact centre, where call handling times are closely monitored.

Various further advantages may include:
removing the further entity, call processor, as a point of failure
increasing capacity
increasing cost-efficiency, especially when licensing is cloud-based rather than per-seat
reducing regulatory obligations, e.g., GDPR, which need to be applied only when necessary

Additional advantages may include:
placing of entities out-of-scope for regulatory requirements such as PCI
compatibility with call recording systems
no requirement for conference bridges to be provided by the contact centre
no additional call charges
absence of any special requirements on the PSTN to support call transfers and re-routing

Any apparatus feature as described herein may also be provided as a method feature, and vice versa.

Any feature in one aspect of the invention may be applied to other aspects of the invention, in any appropriate combination. In particular, method aspects may be applied to apparatus aspects, and vice versa. Particular combinations of the various features described and defined in any aspects of the invention can be implemented and/or supplied and/or used independently.

The invention also provides a computer program and a computer program product or a machine-readable storage medium (and optionally a supporting operating system) comprising instructions or software code adapted, when executed on a data processing apparatus such as a processor, to perform any of the methods described herein, including any or all of their component steps and/or comprises any of the apparatus features described herein. Also provided is a computer readable medium having stored thereon the aforesaid computer program. Also provided is a signal embodying the aforesaid computer program and a method of transmitting such a signal. Furthermore, features implemented in hardware may be implemented in software, and vice versa. Any reference to software and hardware features herein should be construed accordingly.

As used herein, means plus function features may be expressed alternatively in terms of their corresponding structure, such as a suitably programmed processor and associated memory.

The invention extends to methods and/or apparatus substantially as herein described with reference to the accompanying drawings.

Where system elements or components are shown communicating via a plurality of data ports the skilled person will understand the exact number of data ports is not prescriptive.

System elements or components and their functionality may be variously combined or distributed, i.e., what is shown in an embodiment as a single element may be implemented in other embodiments as two or more elements; what is shown in an embodiment as multiple elements may also be implemented in other embodiments as fewer or as a single element.

### BRIEF DESCRIPTION OF THE FIGURES

The invention will now be described, purely by way of example, with reference to the accompanying drawings, in which:

FIG. 1 shows a general agent-assisted call;

FIG. 2 shows an agent-assisted call implemented in a SIP-based telephony network according to an example; and

FIGS. 3-11 show the operating steps S1-S11 of call processing system according to an example, specifically:

FIG. 3 shows step S1, initialisation of call re-routing according to an example;

FIG. 4 shows step S2, call splitting according to an example;

FIG. 5 shows step S3, proxy call initialisation according to an example;

FIG. 6 shows step S4, proxy call completion according to an example;

FIG. 7 shows step S5, call pass-through re-rerouting completion according to an example;

FIG. 8 shows step S6, initialising call unwinding according to an example;

FIG. 9 shows step S7, call unwinding according to an example;

FIG. 10 shows step S8, call separation completion according to an example; and

FIG. 11 shows step S9, original call re-establishment according to an example.

### DESCRIPTION

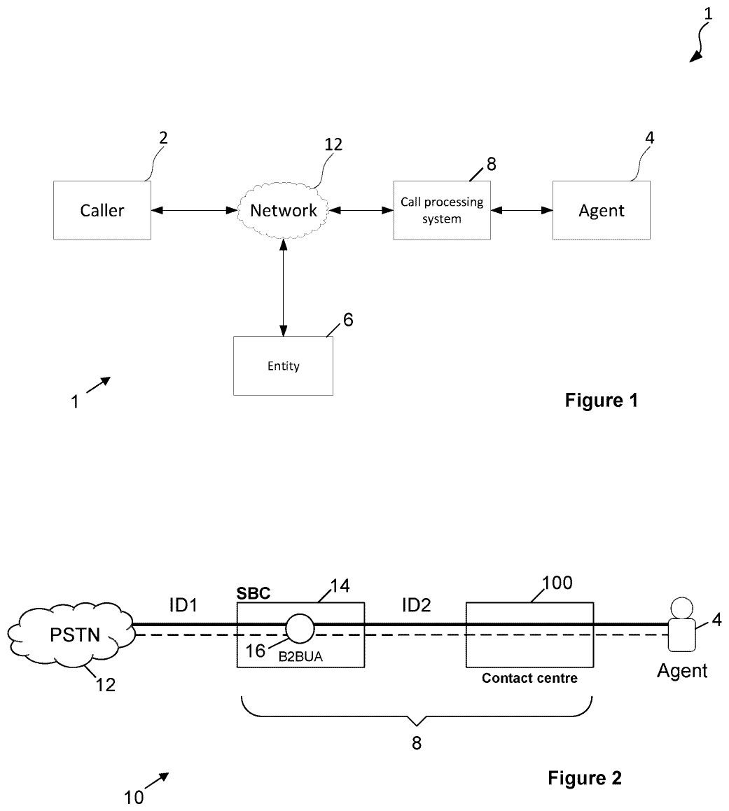

FIG. 1 shows a general agent-assisted call processing system 1, in which a caller 2 is assisted by an agent 4 when undertaking a transaction, such as payment for a good or service, or more generally when providing sensitive information to an entity 6.

Agent 4 may be an employee of the entity 6. For example, agent 4 may be a store assistant. Alternatively, agent 4 may be related only indirectly or entirely unrelated to the entity 6. For example, agent 4 may employed by a contact centre or call centre engaged by a store or merchant. Agent 4 may be a human or machine.

Entity 6 may be a merchant or service provider. Alternatively, entity 6 may be a payment processor, credit card issuer or a bank, such that entity 6 may be in control of funds relating to the caller 2, wherein preforming the transaction involves the caller 2 authorising the entity 6 to release the funds thereby paying for goods or a service.

Network 12, which facilitates communication between the various parties (caller 2, agent 4, and the entity 6), may, for example, be a public switched telephone network (PSTN), a packet-switched network, a local or area network, a mobile phone network or the internet.

In some embodiments network 12 comprises a plurality of different, interconnected networks, which each may perform one or more parts of the described communication, e.g., PSTN for voice traffic, internet for payment traffic etc.

Call processing system 8 is adapted to process a call comprising communication signals transmitted from caller 2 to agent 4. Call processing system 8 may, for example, comprise a telephone system at a call centre, adapted to analyse and route calls to appropriate agents 4.

Call processing system 8 may be adapted to process communications signals in order to prevent sensitive information from being disclosed to the agent.

Further, call processing system 8 may be adapted to identify and process only those communications signals that potentially comprise sensitive information. This may be referred to operating in “secure mode”.

Generally, the call may be understood to comprise audio and data communications signals. Other communications and signals may be present, potentially being processed concurrently, e.g., a live chat session.

Caller 2, the agent 4, and the entity 6 typically communicate via telephones and/or one or more computing devices. Data may be entered (and optionally modified or corrected) via a telephone keypad or a keyboard or may be extracted from an audio stream using speech-to-text software. Various devices may be used to receive and/or send information. For example, caller 2 may transmit payment information via a mobile phone and the agent 4 may use a computer to complete a payment using a website of entity 6.

Agent 4 typically interacts with the call processing system 8 via a dedicated application accessed via a personal computer or via a web browser.

FIG. 2 shows an agent-assisted call processing system 10 implemented in a SIP-based telephony network according to an example.

In the case of a “SIP call”, there are fundamentally two logical connections: the media and the signalling. The signalling is transmitted in the SIP protocol. The media encompasses audio (and optionally video) via the RTP protocol and DTMF ‘tones’ or digits via the RTP EVENT protocol. Both RTP and RTPEVENT take the exact same path, and so are normally shown as one data stream.

Network 12 may comprise the public switched telephone network (PSTN), as generally refers to the worldwide circuit-switched telephony network.

Caller 2 (not shown) connects via network 12 to communicate with agent 4 at contact centre 100. Agent 4 typically interacts with call processor 20—which is introduced ‘on demand’ for handling (including receiving or “capturing”) sensitive information provided by the caller, as during ‘secure mode’-via a dedicated application accessed via a personal computer or via a web browser. Agent 4 may interact with call processor 20 to control its operation, the capture process and/or the subsequent processing of the captured data e.g., for payment. In some embodiments, wherein call processor 20 comprising constituent components such as CCM and DPM, agent 4 interacts with CCM (for example via tones such as DTMF) to control call handling and with the DPM to control and manage the capture process and/or subsequent payments.

The call is routed via session border controller (SBC) 14 comprising a back-to-back user agent (B2BUA) 16 which acts to isolate essentially public-facing (towards the PSTN 12) and private-facing (towards the contact centre 100 and agent 4) sides of the call, which are identified as SIP call ID 1 and ID 2 respectively.

The degree of isolation between public- and private-facing sides may be an implementation detail.

In the context of an SBC there is usually a focus on security, segmentation and interoperability, hance a typical SBC is adapted to validate and sanitise incoming data, then regenerate it for onward transmission.

In other examples, a more relaxed approach may be taken; however, the SIP signalling messages (and the media also) nevertheless likely undergo some degree of regeneration, having been absorbed into the internal formats of the SBC software.

In the majority of cases, SIP signalling messages (and media) effectively pass through, regardless of how differently this is expressed (e.g., “start a call”, “end a call”)—unless security rules indicate they should be blocked.

The B2BUA is typically implemented in software. This may run on a COTS (commercial-off-the-shelf) server or potentially on a dedicated hardware appliance, for example a COTS server augmented with specialist hardware for higher throughput.

In some embodiments, SBC 14 may be an off-the-shelf component modified by re-programming or otherwise to have the functionality described.

The equivalent in FIG. 2 of call processing system 8 of FIG. 1 is therefore the combination of SBC 14 and contact centre 100. Other combinations of elements are also possible.

Identification and processing of only those communications signals that potentially comprise sensitive information is achieved in call processing system 10 at the application layer of the OSI (Open Systems Interconnection) networking model rather than at the IP layer as may be used in other approaches.

The salient point is that the method and apparatus described uses the telephony protocol (e.g., SIP) in the re-routing of the call path. That is, the telephony “application” in the SBC is establishing new telephone calls and so it has an active awareness of when communications signals that potentially comprise sensitive information are being transmitted. By comparison, as disclosed in a co-pending patent application PCT/GB2021/052577 of the same applicant, re-routing may alternatively be achieved at the IP networking level, thereby avoiding any need for devices having such awareness.

The embodiments described below are shown as being implemented using SIP (session initiation protocol); however, the principles have broader applicability and key concepts may be implemented in other protocols.

For example, in the case of ISDN, the separation between signalling and media remains, albeit neither SIP nor RTP is the bearing protocol. According to an example, DTMF digits are not carried via a separate protocol, but instead travel as sound along with the rest of the media. In this case, any device which wishes to receive them can implement a decoding function to recognise the specific tone patterns from a sequence of audio samples.

These two are the primary forms of telephony in enterprise use today. Other protocols (e.g., SS7, H.323) are closely related to ISDN, and follow a similar approach.

The following describes the operating steps S1-S9 of call processing system 10.

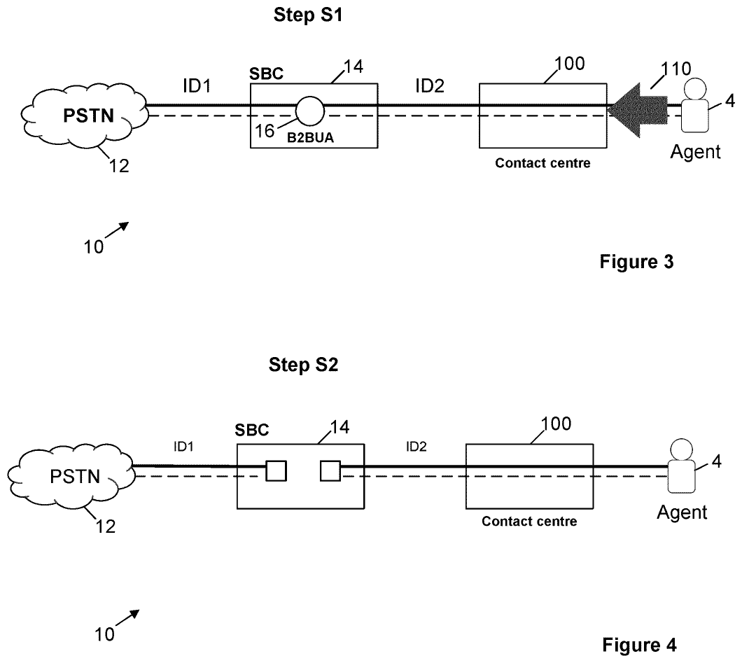

FIG. 3 shows step S1, initialisation of call re-routing according to an example. This can be performed on an ‘on-demand’ basis. In an implementation, initialisation can be triggered by the agent 4 in various ways, e.g.:
Transmission of a data or trigger signal 110 to SBC 14, e.g.,
   DTMF tone
   SIP message (e.g., INFO)
   Voice indication, where the system (e.g., SBC 14) has speech recognition capabilities
   CTI-based initialisation, in which some (preferably unique) information present in the telephony signalling between SBC 14 and contact centre 100 is included in an API call to SBC 14 to indicate that the call which contains this data should be re-routed through call processor 20
Transferring or relaying the call to a “magic number” or range of numbers, i.e., a specific telephone number or set of numbers used primarily or exclusively for the processing sensitive information. Typically this involves a hand-over from the initial agent to another, second-level agent.

Transferring a call to a “magic number” can be performed in a similar way to transferring to a non-magic number, e.g., by an agent key press resulting in e.g., a SIP “REFER” request message which specifies the number the call is to be referred to. If that number is listed as a “magic number”, SBC 14 does not to act on the overt meaning of the request, but instead treats it as a request for “secure mode”.

Preferably, the agent trigger signal 110 comprises an identifier providing agent-unique information for later use during the call process.

SBC 14 is adapted to recognise the trigger signal; no changes to the SIP call are required.

FIG. 4 shows step S2, call splitting according to an example. A logical split of the call is performed at SBC 14, i.e., the call is effectively placed on hold. Each side of the call, PSTN 12 and contact centre 100, are unaware that the call has been split (no SIP messages are sent to either party). Media flow ceases temporarily, but the entire subsequent process occurs quickly enough (e.g., a few hundred ms) that PSTN 12 and contact centre 100 treat this as normal packet loss.

In some embodiments, especially if the process occurs more slowly, ‘comfort noise’ may be transmitted to indicate to caller and agent that the call has not been dropped. Various failover processes may be taken in case the subsequent processing of the call does not occur, e.g., re-connecting the two parts of the call after a time-out period.

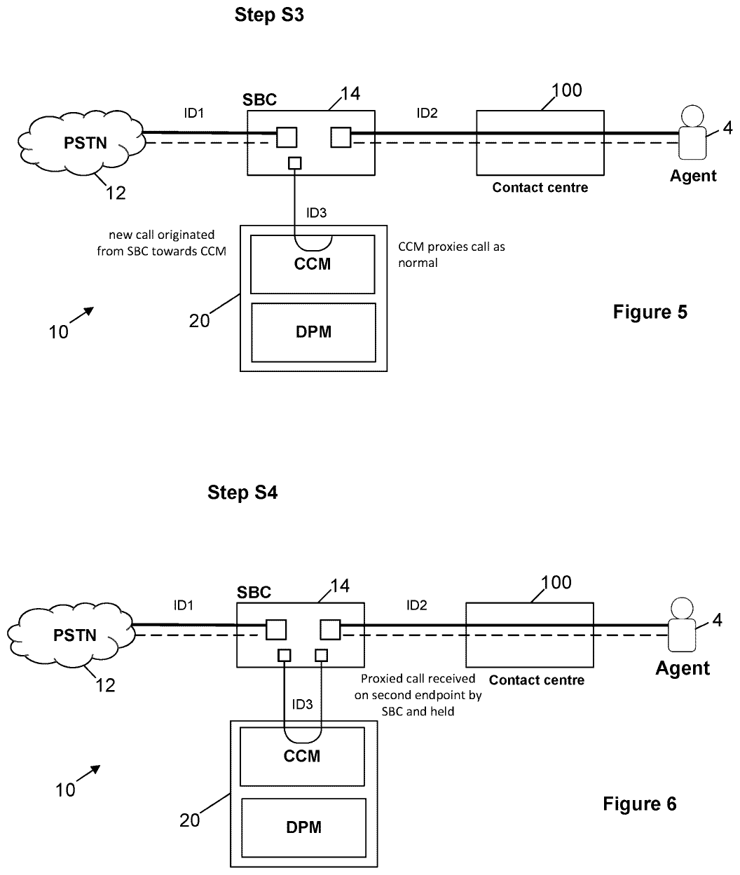

FIG. 5 shows step S3, proxy call initialisation according to an example. With the original call split at the SBC 14, a new call (SIP call ID 3) is originated from a first endpoint of the SBC 14 towards call processor 20, which acts as a call proxy, i.e., simply passing on the messages it receives, making only minimal amendments (e.g., for purposes of IP addressing).

The new call comprises correlation information which allows SBC 14 to know which contact centre call leg this call relates to e.g.:
Custom SIP header (e.g.: “X-Source-Call-ID: 2”), e.g.,
   INVITE sip: 1234@192.168.1.65 SIP/2.0
   Via: SIP/2.0/UDP
   192.168.1.83:5060;branch=z9hG4bK22f26a45;rport
   Max-Forwards: 70
   From: “some.user” <sip: 2000@192.168.1.83>;tag=as38331695
   To: <sip: 1234@192.168.1.65>
   Contact: <sip:2000@192.168.1.83:5060>
   Call-ID:
   3cb026a40b392c4f280ce0d44d58cf0b@192.168.1.83:5060
   CSeq: 102 INVITE
   User-Agent: SIG
   Date: Wed, 5 Dec. 2012 11:53:59 GMT
   Allow: INVITE, ACK, CANCEL, OPTIONS, BYE, REFER,
   SUBSCRIBE, NOTIFY, INFO, PUBLISH
   Supported: replaces, timer
   X-Source-Call-ID: 2
Correlation identifier embedded in existing SIP header, e.g., to: field

Preferably, the message also comprises:
original to and from numbers (enables call routing and reporting by the call processor)
data provided by agent to trigger call re-routing, as this can then be used to correlate the human individual with the phone call

Two types of correlation may be occurring:
1) To allow the SBC to understand that SIP Call-ID 3 is related to SIP Call-ID 1 and SIP Call-ID 2
2) Optionally, to allow call processor 20 to know some unique piece of information about the agent 4, so their ‘capture page’ (a web page or other interface used by agent 4) is linked to the call

In some embodiments SBC 14 is controlled by an additional, separate entity.

FIG. 6 shows step S4, proxy call completion according to an example. The proxied call is received at a second endpoint by SBC 14 and held. There are now three SIP IDs in use.

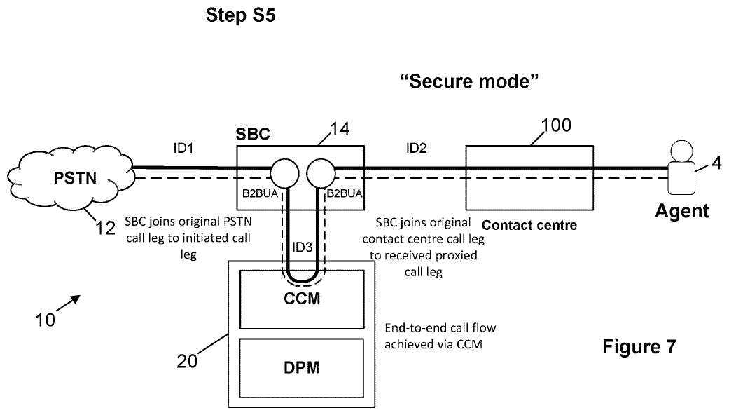

FIG. 7 shows step S5, call pass-through re-rerouting completion according to an example. SBC 14 joins original PSTN call leg (ID1) to call leg initiated to call processor 20 and the original contact centre call leg (ID2) to the proxied call leg received from the call processor 20.

The end-to-end call flow is thus achieved via call processor 20.
PSTN and Contact Centre are unaware (no SIP messages sent)
Media flow resumes
Agent proceeds as normal

If correlation information was provided to call processor 20 the call can be placed into “secure mode” without the agent needing to manually enter a call reference (number), CR, the sequence of digits which the agent sends via DTMF (typically entered via a telephone keypad) to signal a) that they wish to enter “secure mode”, and b) how this telephone call correlates with the agent browser session to the call processor 20.

SBC 14 therefore provides additional security.

At this point the call processing system 10 is in “secure mode”. Sensitive information provided by the caller 2 and encoded in the call data is processed at call processor 20 and prevented by call processor 20 from reaching the contact centre 100 and agent 4, for example in accordance with methods described in the applicant's WO2009136163.

Processing the sensitive information may involve call processor 20 interacting with an external entity, e.g., entity 6 as shown in FIG. 1, which may be a payment provider or provide identification/authentication or other services.

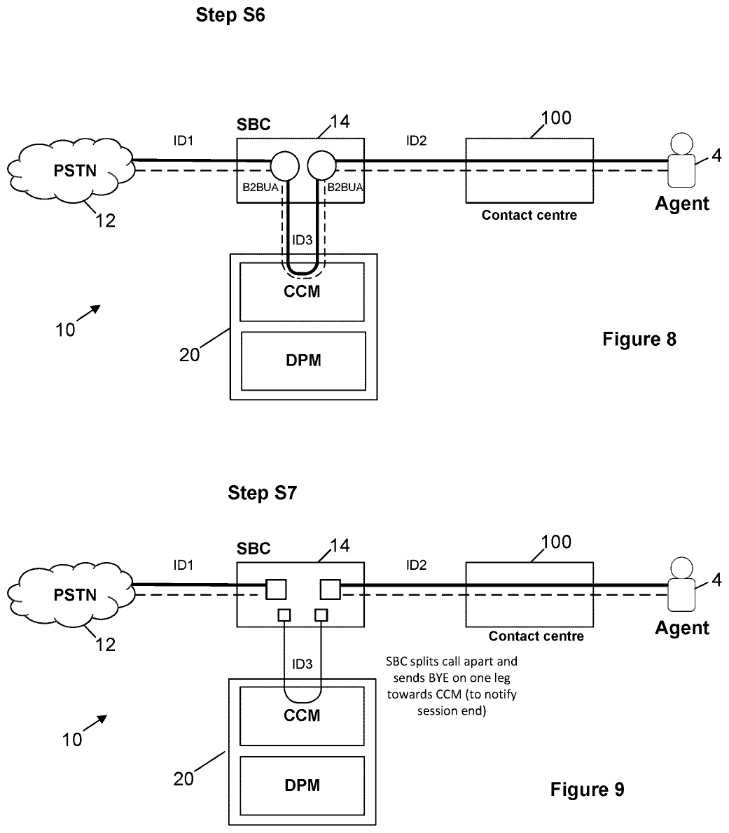

FIG. 8 shows step S6 according to an example, initialising call unwinding, i.e., initialising the process of reversing the arrangement of call legs, with the end goal of reinstating the original configuration. When the call processor 20 is no longer required in the call it may optionally be removed from the call. This requires a mechanism to unwind the re-routing and return call to the original routing. This may be triggered in various ways, e.g.:
A termination signal such as a ‘BYE’ instruction, optionally with additional special information sent from call processor 20. This may, for example, be when call processor 20 exits “secure mode”, or when a payment has been successfully completed.
Triggered by the agent via any of the mechanisms previously discussed. This may comprise different data content to signal request ending the “on-demand” phase.
Inferred from receipt of the trigger mechanism for a second time when call processor 20 is already in the call, indicating the call processor 20 should be removed.

Generally, any mutually understood mechanism may be used to trigger removal of the call processor from the call. For example:
a repeat of the original signal
a different signal, delivered via the same or a different mechanism as the original signal
inferred from an outcome of the secure data processing step, e.g., all expected secure data has been captured from the caller, or the process (e.g., payment) which uses that data has completed successfully
an entirely different channel (such as an API signal sent from the agent's browser to the call processor), which may not have been a viable option at earlier stages, for example because all the data needed to correlate voice and data sessions was not yet available.

FIG. 9 shows step S7 according to an example, call unwinding. SBC 14 splits calls apart and sends a ‘BYE’ termination signal on one leg towards call processor 20 to notify session end.
Calls split apart, e.g., placed on hold
PSTN 12 and Contact Centre 100 are unaware (no SIP messages are sent)
Media flow will cease temporarily; however, the entire process is fast enough that PSTN 12 and contact centre 100 treat this as normal packet loss

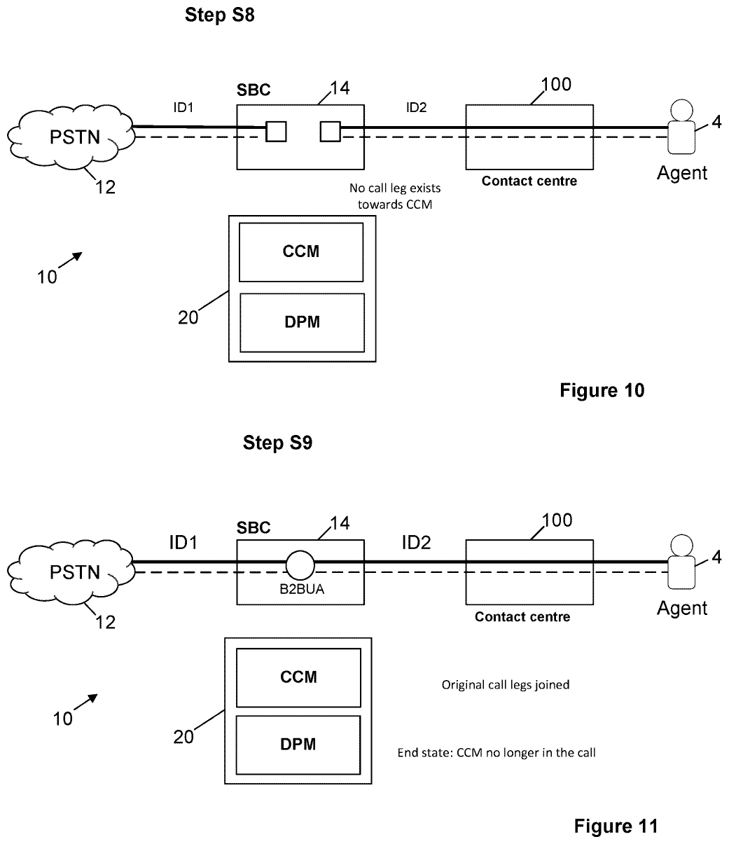

FIG. 10 shows step S8 according to an example, call separation completion. No call legs exist towards call processor 20.

FIG. 11 shows step S9 according to an example, original call re-establishment. The process ends with the original call legs re-joined. call processor 20 is no longer in the call.

It will be understood that the present invention has been described above purely by way of example, and modifications of detail can be made within the scope of the invention.

Reference numerals appearing in the claims are by way of illustration only and shall have no limiting effect on the scope of the claims.

1. A method of processing a communication or call between a first entity and a second entity, the method comprising:
routing an initial call between the first entity and the second entity via an intermediate entity;
monitoring for a trigger signal; and
upon detecting the trigger signal, re-routing the call additionally via a further entity adapted to process the call for sensitive information encoded in the call received from the first entity.

2-22. (canceled)
